(19) United States
(12) Patent Application Publication
(10) Pub. No.: US 2026/0244406 A1
(43) Pub. Date: Aug. 20, 2026

(54) CHOLESKY DECOMPOSITION METHOD FOR FINDING INVERSE MATRIX USING SPARSE MATRIX AND APPARATUS THEREFOR

(71) Applicants: HYUNDAI MOTOR COMPANY, SEOUL (KR); KIA CORPORATION, SEOUL (KR)

(72) Inventors: Jamal Muhammad Zahak, Hwaseong-si (KR); Dong Hyun Lee, Hwaseong-si (KR); Dong Jin Hyun, Hwaseong-si (KR); Ju Young Yoon, Hwaseong-si (KR)

(73) Assignees: HYUNDAI MOTOR COMPANY, SEOUL (KR); KIA CORPORATION, SEOUL (KR)

(21) Appl. No.: 19/307,000

(22) Filed: Aug. 21, 2025

(30) Foreign Application Priority Data
Feb. 19, 2025 (KR) 10-2025-0021719

(51) Int. Cl. G06F 7/78

(52) U.S. Cl. CPC G06F 7/78

(57) ABSTRACT

The present disclosure relates to a Cholesky decomposition method for computing an inverse matrix using a sparse matrix, and a device utilizing the same. The Cholesky decomposition method in a computing device includes receiving a dense matrix “A” as input, generating a lower triangular matrix “L” and a transposed matrix L^{T} of the lower triangular matrix by performing Cholesky decomposition on the dense matrix “A”, computing an inverse matrix L⁻¹ of the lower triangular matrix “L” using triangular solving, computing an inverse matrix A⁻¹ of the dense matrix “A” using the transposed matrix L^{T} and the inverse matrix L⁻¹ of the lower triangular matrix “L”, and outputting the inverse matrix A⁻¹.

### CROSS-REFERENCE TO RELATED APPLICATION(S)

This application claims the benefit of priority to Korean Patent Application No. 10-2025-0021719, filed in the Korean Intellectual Property Office on Feb. 19, 2025, the entire contents of which are incorporated herein by reference.

### TECHNICAL FIELD

The present disclosure relates to a Cholesky decomposition method, and more particularly, to a Cholesky decomposition method for computing an inverse matrix using a sparse matrix, and predicting the movement of a robot by utilizing the same.

### BACKGROUND

The statistical mechanics approach of Monte Carlo simulation may be useful when a system has a high degree of freedom (or a high number of variables); however, it may be infeasible to obtain an exact solution. Fields that derive from or are related to statistical mechanics may include nonlinear dynamics, chaos theory, plasma physics, thermodynamics, and fluid dynamics. While simple problems in statistical mechanics may be solved analytically using series expansions or approximation methods, more complex and modern problems typically use (e.g., require) numerical solutions of equations or rely on computer simulations to obtain results.

Among the various approaches to solving complex systems, the Monte Carlo simulation method is one of the most widely used. The Monte Carlo method refers to an algorithm that computes the value of a function probabilistically using random numbers. The Monte Carlo method is used in mathematics, physics, and other fields, particularly for problems that may not be expressed in a closed-form or that are too complex for direct computation.

Monte Carlo simulations often utilize Cholesky decomposition (or Cholesky factorization), which is employed in the decomposition of Hermitian matrices and positive-definite matrices.

The result of Cholesky decomposition is expressed as the product of a lower triangular matrix “L” and its conjugate transpose matrix L^{T}, denoted as LL^{T}.

Cholesky decomposition is currently used for numerical analysis and has been applied in Monte Carlo simulations. In particular, Cholesky decomposition is used in various real-world applications involving systems of linear equations. Compared to LU (Lower-Upper) decomposition, Cholesky decomposition may be approximately twice as efficient due to its ability to utilize matrix symmetry and may eliminate pivoting.

Cholesky decomposition finds applications in a variety of areas, including: finding the solution ‘x’ in the equation Ax=b given matrix ‘A’ and vector ‘b’; normal equations for least squares problems; discretization of self adjoint partial differential equation boundary value problems; Hessians of convex functions in optimization (where the Hessian is often made convex); and systems of equations arising in primal-dual barrier methods for linear programming.

A sparse matrix refers to a matrix in which the majority of elements are zero. Various types of real-world data, such as e-commerce purchase history, social network relationships, and document-to-word associations, are stored and utilized in the form of sparse matrices. In recent years, artificial intelligence models designed for sparse matrices, including recommendation systems and graph neural networks, have been adopted.

Robot control may be carried out through complex computational logic based on sensor data collected from various sensors; however, it may be useful to use Cholesky decomposition of sparse matrices for robot control.

### SUMMARY

The present disclosure has been made to address the above-mentioned problems occurring in the prior art.

An aspect of the present disclosure provides a Cholesky decomposition method for computing an inverse matrix using a sparse matrix, and a device utilizing the same.

An aspect of the present disclosure provides a real-time computing device, including a robot controller, to which a (e.g., fast and efficient) Cholesky decomposition technique for computing an inverse matrix using a sparse matrix is applied.

An aspect of the present disclosure provides a Cholesky decomposition technique for computing an inverse matrix using a sparse matrix, which is applicable to heterogeneous devices and/or systems.

An aspect of the present disclosure provides a (e.g., fast and efficient) Cholesky decomposition technique for computing the inverse matrix of a sparse matrix, applicable to machine learning and statistical applications.

The present disclosure are not limited to the aforementioned problems, and any other technical problems not mentioned herein will be clearly understood from the following description by those skilled in the art to which the present disclosure pertains.

According to an aspect of the present disclosure, a Cholesky decomposition method in a computing device, includes receiving a dense matrix “A” as input, generating a lower triangular matrix “L” and a transposed matrix L^{T} of the lower triangular matrix by performing Cholesky decomposition on the dense matrix “A”, computing an inverse matrix L⁻¹ of the lower triangular matrix “L” using triangular solving, computing an inverse matrix A⁻¹ of the dense matrix “A” using the transposed matrix L^{T} and the inverse matrix L⁻¹ of the lower triangular matrix “L”, and outputting the inverse matrix A⁻¹.

In an example embodiment, the computing of the transposed matrix L^{T} of the lower triangular matrix may include generating an elimination tree corresponding to the lower triangular matrix “L”, sequentially traversing nodes of the elimination tree to extract respective column patterns corresponding to the inverse matrix L⁻¹ of the lower triangular matrix “L”, and generating the transposed matrix L^{T} of the lower triangular matrix based on the extracted column patterns.

In an example embodiment, the elimination tree corresponding to the lower triangular matrix “L” may be the same as (e.g., identical to) an elimination tree corresponding to the inverse matrix L⁻¹ of the lower triangular matrix.

In an example embodiment, a non-zero pattern of each column of the inverse matrix L⁻¹ of the lower triangular matrix may be extracted by identifying a reach from a lowest-level node to a highest-level node of the elimination tree.

In an example embodiment, the reach may be identified with respect to non-zero elements of the dense matrix “A”.

In an example embodiment, the lower triangular matrix “L” and the inverse matrix L⁻¹ of the lower triangular matrix may be sparse matrices.

In an example embodiment, the triangular solving may use an equation Lx=b, where “L” is the lower triangular matrix, “x” is a vector element corresponding to a column pattern of the inverse matrix L⁻¹ of the lower triangular matrix, and “b” is a vector element indicating a column of L⁻¹.

In an example embodiment, the inverse matrix A⁻¹ may be computed as a product of an inverse matrix (L^{T})⁻¹ of the transposed matrix and the inverse matrix L⁻¹ of the lower triangular matrix, where the dense matrix “A” is a symmetric positive-definite matrix, and n is a natural number.

In an example embodiment, the computing device may include a robot control module, and the Cholesky decomposition method may be embedded in the robot control module together with a Quadratic Programming (QP) method and a Model Predictive Control (MPC) method for whole-body control of a robot.

In an example embodiment, the computing device may be equipped with a real-time module configured to maintain processing time at fixed intervals.

An aspect of the present disclosure provides a computing device including a processor that executes instructions, and a memory that stores the instructions, wherein the instructions are implemented to receive a dense matrix “A” as input, generate a lower triangular matrix “L” and a transposed matrix L^{T} of the lower triangular matrix by performing Cholesky decomposition on the dense matrix “A”, compute an inverse matrix L⁻¹ of the lower triangular matrix “L” using triangular solving, compute an inverse matrix A⁻¹ of the dense matrix “A” using the transposed matrix L^{T} and the inverse matrix L⁻¹ of the lower triangular matrix “L”, and output the inverse matrix A⁻¹.

In an example embodiment, the processor may generate an elimination tree corresponding to the lower triangular matrix “L”, sequentially traverse nodes of the elimination tree to extract respective column patterns corresponding to the inverse matrix L⁻¹ of the lower triangular matrix “L”, and generate the transposed matrix L^{T} of the lower triangular matrix based on the extracted column patterns.

In an example embodiment, the elimination tree corresponding to the lower triangular matrix “L” may be the same as (e.g., identical to) an elimination tree corresponding to the inverse matrix L⁻¹ of the lower triangular matrix.

In an example embodiment, the processor may extract a non-zero pattern of each column of the inverse matrix L⁻¹ of the lower triangular matrix by identifying a reach from a lowest-level node to a highest-level node of the elimination tree.

In an example embodiment, the processor may identify the reach with respect to non-zero elements of the dense matrix “A”.

In an example embodiment, the lower triangular matrix “L” and the inverse matrix L⁻¹ of the lower triangular matrix may be sparse matrices.

In an example embodiment, the triangular solving may use an equation Lx=b, where “L” is the lower triangular matrix, “x” is a vector element corresponding to a column pattern of the inverse matrix L⁻¹ of the lower triangular matrix, and “b” is a vector element indicating a column of L⁻¹.

In an example embodiment, the inverse matrix A⁻¹ may be computed as a product of an inverse matrix (L^{T})⁻¹ of the transposed matrix and the inverse matrix L⁻¹ of the lower triangular matrix, where the dense matrix “A” is a symmetric positive-definite matrix, and n is a natural number.

In an example embodiment, the computing device may include a robot control module, and the Cholesky decomposition may be embedded in the robot control module together with a Quadratic Programming (QP) method and a Model Predictive Control (MPC) method for whole-body control of a robot.

In an example embodiment, the computing device may be equipped with a real-time module configured to maintain processing time at fixed intervals.

### BRIEF DESCRIPTION OF THE DRAWINGS

The above and other objects and features of the present disclosure will be more apparent from the following detailed description taken in conjunction with the accompanying drawings:

FIG. 1 is a diagram for describing the Cholesky decomposition method for a sparse matrix according to an example embodiment of the present disclosure;

FIG. 2 shows a graphical interpretation of the Cholesky decomposition method for the sparse matrix of FIG. 1;

FIG. 3 is a diagram for describing the Cholesky decomposition method for sparse matrices according to another embodiment of the present disclosure;

FIG. 4 is a diagram for describing the characteristics of the elimination tree of the lower triangular matrix “L” according to an example embodiment of the present disclosure;

FIG. 5 is a diagram for describing the reason why the elimination tree of the lower triangular matrix “L” is the same as (e.g., identical to) that of L⁻¹, according to an example embodiment of the present disclosure;

FIG. 6 is a diagram for describing a graph traversal method for an elimination tree according to an example embodiment of the present disclosure;

FIG. 7 is a diagram for describing a method for numerically computing a sparse matrix L 1 according to an example embodiment of the present disclosure;

FIG. 8 is a diagram for describing a method for obtaining the inverse matrix of “A” using a sparse matrix L⁻¹, according to an example embodiment of the present disclosure;

FIG. 9 is a flowchart for describing a Cholesky decomposition method for obtaining an inverse matrix using a sparse matrix according to an example embodiment of the present disclosure;

FIG. 10 is a flowchart for describing a detailed method for computing the inverse matrix L⁻¹ of the lower triangular matrix “L” of FIG. 9;

FIG. 11 illustrates a method for computing the inverse matrix A⁻¹ of a dense matrix “A” utilizing the inverse matrix of a symmetric positive definite sparse matrix via LL^{T} factorization according to an example embodiment of the present disclosure, as well as performance test results of prior art;

FIG. 12 shows an example of a device to which the Cholesky decomposition method for computing an inverse matrix using a sparse matrix is applied;

FIG. 13 is a block diagram of a control system for a four-legged robot according to an example embodiment of the present disclosure; and

FIG. 14 illustrates a computing device according to an example embodiment of the present disclosure.

### DETAILED DESCRIPTION

Hereinafter, the present disclosure will be described in detail with reference to the example drawings. In adding the reference numerals to the components of each drawing, it should be noted that the same or similar (e.g., identical or equivalent) component is designated by the same numeral even when they are displayed on other drawings. Further, in describing an example embodiment of the present disclosure, a detailed description of certain features or functions may not be included to prevent obscuring the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise provided, all terms used herein, including technical or scientific terms, have the same or similar meanings as those generally understood by those skilled in the art to which the present disclosure pertains. Such terms as those provided in a generally used dictionary are to be interpreted as having meanings equal to or similar to the contextual meanings in the relevant field of art, and are not to be interpreted as having ideal or excessively formal meanings unless clearly defined as having such in the present application.

In the following, a brief description of Cholesky decomposition will be given to facilitate understanding of the present disclosure.

The Cholesky decomposition method may be used to factor a symmetric positive definite sparse matrix into two triangular matrices. This may be expressed in the form of an equation, as shown in Equation 1 below.

$$A = {LL}^{T} \qquad < Equation 1 >$$

Where A is a symmetric positive definite sparse matrix, “L” is a lower triangular matrix, and L^{T} is the transpose of the lower triangular matrix, which forms an upper triangular matrix.

In computing, a common issue is to find the value of vector “x” in an equation, as shown in Equation 2.

$$b = Ax \qquad < Equation 2 >$$

Where “A” is a symmetric positive definite sparse matrix used for the Cholesky method, and “x” and “b” are vectors.

When using Cholesky decomposition, the sparse matrix “A” may be decomposed into two matrices—an upper triangular matrix and a lower triangular matrix—as shown in Equation 3 below, according to Equation 1.

$$b = ( {LL}^{T} ) x \qquad < Equation 3 >$$

By applying the method in Equation 3, the algorithm may have a faster solving process.

$$[ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ]$$

When “A”=in A=LL^{T}, after decomposition, it may be expressed as

$$A = [ \begin{matrix}{l}_{11} & 0 & 0 & 0 \\ {l}_{21} & {l}_{22} & 0 & 0 \\ {l}_{31} & {l}_{32} & {l}_{33} & 0 \\ {l}_{41} & {l}_{42} & {l}_{43} & {l}_{44}\end{matrix} ] [ [ \begin{matrix}{l}_{11} & {l}_{12} & {l}_{31} & {l}_{41} \\ 0 & {l}_{22} & {l}_{32} & {l}_{42} \\ 0 & 0 & {l}_{33} & {l}_{43} \\ 0 & 0 & 0 & {l}_{44}\end{matrix} ]$$

For example, to solve a system of linear equations as in Equation 4 below, the above-mentioned decomposed matrices may be used.

$${a}_{11} {x}_{1} + {a}_{12} {x}_{2} + {a}_{13} {x}_{3} = {b}_{1} {a}_{21} {x}_{1} + {a}_{22} {x}_{2} + {a}_{23} {x}_{3} = {b}_{2} {a}_{31} {x}_{1} + {a}_{32} {x}_{2} + {a}_{33} {x}_{3} = {b}_{3} \qquad < Equation 4 >$$

When a system of linear equations is expressed as

$$[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{x}_{1} \\ {x}_{2} \\ {x}_{3}\end{matrix} ] = [ \begin{matrix}{b}_{1} \\ {b}_{2} \\ {b}_{3}\end{matrix} ] ,$$

it may be expressed as Ax=b, where the purpose of the decomposition is to compute the vector “x” from the given “A” and “b”.

By applying the decomposed “A”, LL^{T}x=b may be obtained and “x” may be obtained by performing a Lower Triangular solve (Ly=b) using forward elimination or an Upper Triangular solve (L^{T} x=y) using backward elimination.

As a result, the above system of linear equations may be solved through the following series of mathematical developments.

$$Ax = b$$

$${LL}^{T} x = b$$

$${U}^{T} Ux = b$$

$${U}^{T} y = b ( Lower Triangular solve using forward elimination )$$

$$Ux = y ( Upper Triangular solve using backward elimination )$$

In the following, a brief description of the concept of sparse matrices to aid in the understanding of the present disclosure is described.

A sparse matrix refers to a matrix in which most of the values are zero, unlike the data structure of a dense matrix.

The fastest way to process a sparse matrix is to provide (e.g., define) a data structure with six key data members. These key members may include: column pointers, row indices, values, number of columns, number of rows, and number of non-zero values.

The matrix “A” below may be a sparse matrix, as it contains 50% of values being zero.

$$A = [ \begin{matrix}4.5 & 0 & 3.2 & 0 \\ 0 & 2.9 & 0 & 0.9 \\ 0 & 1.7 & 3.0 & 0 \\ 3.5 & 0 & 0 & 1.0\end{matrix} ]$$

The data structure of the matrix “A” is as follows:

$$Column pointers : Ap = [ \begin{matrix}0 & 2 & 4 & 6 & 8\end{matrix} ]$$

$$Row indices : Ai = [ \begin{matrix}0 & 3 & 1 & 2 & 0 & 2 & 1 & 3\end{matrix} ]$$

$$Values : Ax = [ \begin{matrix}4.5 & 3.5 & 2.9 & 1.7 & 3.2 & 3. & 0.9 & 1.\end{matrix} ]$$

$$Number of columns : n\_col = 4$$

$$Number of rows : n\_rows = 4$$

$$Number of non - zero values : n\_nz = 8$$

The following briefly describes the Cholesky decomposition method for dense matrices.

As shown in Equation 5 below, it is assumed that A is an N by N symmetric positive definite matrix obtained by factoring “A” into L and L^{T} as shown in Equation 5 below.

$$A = {LL}^{T} \qquad < Equation 5 >$$

In each iteration of the algorithm, Equation 5 may be decomposed in the manner shown in Equation 6 below.

$$[ \begin{matrix}{A}_{11} & {a}_{12} \\ {a}_{12}^{T} & {a}_{22}\end{matrix} ] = [ \begin{matrix}{L}_{11} & 0 \\ {l}_{12}^{T} & {l}_{22}\end{matrix} ] [ \begin{matrix}{L}_{11}^{T} & {l}_{12} \\ 0 & {l}_{22}\end{matrix} ] \qquad < Equation 6 >$$

Where A₁₁ is an (N−1)×(N−1) matrix, L₁₁ is an (N−1)×(N−1) matrix, a₁₂^{T} is a t₁×(N−1) vector, l₁₂^{T} is a 1×(N−1) vector, a₂₂ is a scalar at the N×N position, and l₂₂ is a scalar at the N×N position. In this case, N=2.

From Equation 6, the following three equations may be derived.

$${A}_{11} = {L}_{11} {L}_{11}^{T}$$

$${a}_{11} = {L}_{11} {l}_{11}$$

$${l}_{22} = \sqrt{{a}_{22} - {l}_{12}^{T} {l}_{12}}$$

Specifically, by applying recursive factorization to the leading submatrix “A”, equation A₁₁=L₁₁L₁₁^{T} may be expressed, where the above equation is a recursive equation for obtaining “L” by iterating over the N columns of the matrix “A”. The triangular solve for non-diagonal element a₁₂ may be expressed as a₁₂=L₁₁l₁₂, which represents a lower triangular solve problem using l₁₂ to compute each column of “L” when a₁₂ is known. The dot product for diagonal element l₂₂ may be expressed as l₂₂=\sqrt{a₂₂−l₁₂^{T}l₁₂}, and finally, from the equation, the diagonal element l₂₂ of “L” may be computed.

The MATLAB function for the above-described algorithm (also known as the “Up Looking Cholesky decomposition Method”) may be coded as follows.

function = chol_up(A)
n = size (A) ;
L = zeros (n) ;
for k = 1:n
L (k, 1: k−1) = (L (1: k−1, 1: k−1) \ A (1:k−1, k))’ ;
L (k, k) = sqrt (A (k, k) − L (k,1: k−1) * L (k,1:k−1)’) ;
end

The Cholesky decomposition for a sparse matrix, according to the present disclosure, may also be implemented based on the same underlying idea as the above-described algorithm.

Representative conventional methods to compute the inverse matrix A⁻¹ may include a first method of computing the adjugate matrix Adj(A) of matrix “A” and dividing the adjugate matrix Adj(A) by the determinant |A| and a second method of multiplying matrix “A” by the identity matrix.

$${A}^{- 1} = \frac{Adj ( A )}{\vert A \vert} \qquad < Method 1 >$$

$$[ A : I ] = [ \begin{matrix}{a}_{11} & {a}_{12} & {a}_{13} & {a}_{14} & 1 & 0 & 0 & 0 \\ {a}_{21} & {a}_{22} & {a}_{23} & {a}_{24} & 0 & 1 & 0 & 0 \\ {a}_{31} & {a}_{32} & {a}_{33} & {a}_{34} & 0 & 0 & 1 & 0 \\ {a}_{41} & {a}_{42} & {a}_{43} & {a}_{44} & 0 & 0 & 0 & 1\end{matrix} ] \to [ I : {A}^{- 1} ] \qquad < Method 2 >$$

A process for computing the inverse matrix of a symmetric positive definite (SPD) sparse matrix using LL^{T} factorization will be described below.

In a first phase, matrix “A” may be decomposed into a lower triangular matrix and an upper triangular matrix as follows. For the decomposition of matrix “A”, the previously described Cholesky LL^{T} decomposition method for SPD matrices may be referenced.

$$A = [ \begin{matrix}{l}_{11} & 0 & 0 & 0 \\ {l}_{21} & {l}_{22} & 0 & 0 \\ {l}_{31} & {l}_{32} & {l}_{33} & 0 \\ {l}_{41} & {l}_{42} & {l}_{43} & {l}_{44}\end{matrix} ] [ \begin{matrix}{l}_{11} & {l}_{21} & {l}_{31} & {l}_{41} \\ 0 & {l}_{22} & {l}_{32} & {l}_{42} \\ 0 & 0 & {l}_{33} & {l}_{44} \\ 0 & 0 & 0 & {l}_{44}\end{matrix} ]$$

In a second phase, the inverse matrices of the lower and upper triangular matrices may be computed using the augmented matrix technique.

$$[ L : I ] = [ \begin{matrix}{l}_{11} & 0 & 0 & 0 & 1 & 0 & 0 & 0 \\ {l}_{21} & {l}_{22} & 0 & 0 & 0 & 1 & 0 & 0 \\ {l}_{31} & {l}_{32} & {l}_{33} & 0 & 0 & 0 & 1 & 0 \\ {l}_{41} & {l}_{42} & {l}_{43} & {l}_{44} & 0 & 0 & 0 & 1\end{matrix} ] {\to }^{using forward elimination} [ I : {L}^{- 1} ]$$

$$[ U : I ] = [ \begin{matrix}{l}_{11} & {l}_{21} & {l}_{31} & {l}_{41} & 1 & 0 & 0 & 0 \\ 0 & {l}_{22} & {l}_{32} & {l}_{42} & 0 & 1 & 0 & 0 \\ 0 & 0 & {l}_{33} & {l}_{44} & 0 & 0 & 1 & 0 \\ 0 & 0 & 0 & {l}_{44} & 0 & 0 & 0 & 1\end{matrix} ] {\to }^{using backward elimination} [ I : {U}^{- 1} ]$$

In a third phase, the inverse matrix of matrix “A” is computed.

$$A = LU$$

$${( A )}^{- 1} = {( LU )}^{- 1}$$

$${A}^{- 1} = {U}^{- 1} {L}^{- 1}$$

For dense matrices, L⁻¹ of a 3×3 matrix may be computed as shown in the following equation.

$$[ L : I ] = [ \begin{matrix}{l}_{11} & 0 & 0 & ⋮ & 1 & 0 & 0 \\ {l}_{21} & {l}_{22} & 0 & ⋮ & 0 & 1 & 0 \\ {l}_{31} & {l}_{32} & {l}_{33} & ⋮ & 0 & 0 & 1\end{matrix} ] {\to }^{using forward elimination} [ I : {L}^{- 1} ] = [ \begin{matrix}1 & 0 & 0 & \frac{1}{{l}_{11}} & 0 & 0 \\ 0 & 1 & 0 & - \frac{{l}_{21}}{{l}_{11} {l}_{22}} & \frac{1}{{l}_{22}} & 0 \\ 0 & 0 & 1 & ( - \frac{{l}_{31}}{{l}_{11}} - ) \frac{{l}_{21} {l}_{32}}{{l}_{11} {l}_{22}} ) ) \frac{1}{{l}_{33}} & - \frac{{l}_{32}}{{l}_{22} {l}_{33}} & \frac{1}{{l}_{33}}\end{matrix} ]$$

The above equation may be (e.g., easily) implemented in code. However, when using a dense matrix pattern, the process of computing the inverse matrix becomes (e.g., very) slow and its complexity may increase (e.g., significantly) to O(n³), posing a (e.g., major) drawback. Therefore, the present disclosure may use sparse matrices to address the drawback.

The inverse matrix may be utilized in control for robots (e.g, calculating a joint angles of the robots), as well as in machine learning and statistical applications.

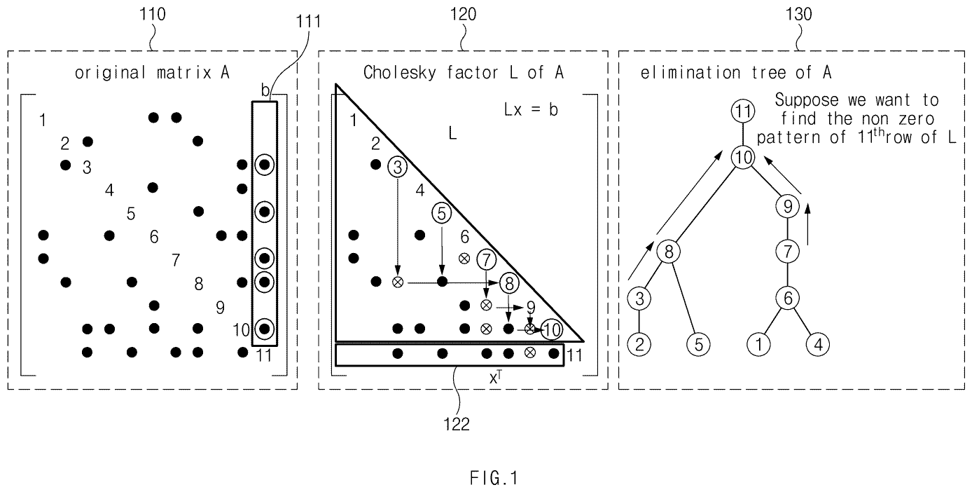

The Cholesky decomposition method for computing the inverse matrix of a dense matrix using a sparse matrix, and an apparatus using the same will be described in detail with reference to FIGS. 1 to 14.

FIG. 1 is a diagram for describing the Cholesky decomposition method for a sparse matrix according to an example embodiment of the present disclosure.

In general, the Cholesky decomposition method for sparse matrices may include the following four main phases:
(1) determining (e.g., finding out) the “elimination tree”;
(2) determining (e.g., finding out) the ‘reach’ of the tree for the pattern of each column of the matrix;
(3) determining (e.g., finding out) the number of column counts;
(4) carrying out the numeric factorization

In other words, the Cholesky decomposition method for sparse matrices may include determining (e.g., finding out) the reach of the elimination tree of matrix “A” to determine (e.g., find out) the pattern of each column of the lower triangular matrix “L” and then determining the pattern of each column of “L”.

Referring to FIG. 1, reference numeral 110 may show an original matrix “A” with 11 rows and 11 columns.

With reference to reference numerals 110 and 120, “x” may be computed from the Cholesky factor (lower triangular matrix “L”) of matrix “A” and the dense vector “b” 111. For example, finding out the non-zero values 122—i.e., the non-zero pattern—of the 11th row of “L” may be performed through the pattern analysis for 3rd, 5th, 7th, and 10th columns of “L”, and numerical factorization based on the elimination tree of “A”, as illustrated by reference numerals 120 and 130.

The elimination tree is a special graph structure for square symmetric matrices and may show a method of preserving the structure of a matrix while eliminating specific elements of the matrix. In MATLAB, the etree function may be used to compute the elimination tree, and the etreeplot function may be used to visually represent the elimination tree, as illustrated by reference numeral 130.

A description of the elimination tree may be found in the article titled “A survey of direct methods for sparse linear systems.” with authors Davis, Timothy A., Sivasankaran Rajamanickam, and Wissam M. Sid-Lakhdar. Acta Numerica 25 (2016):383-566.

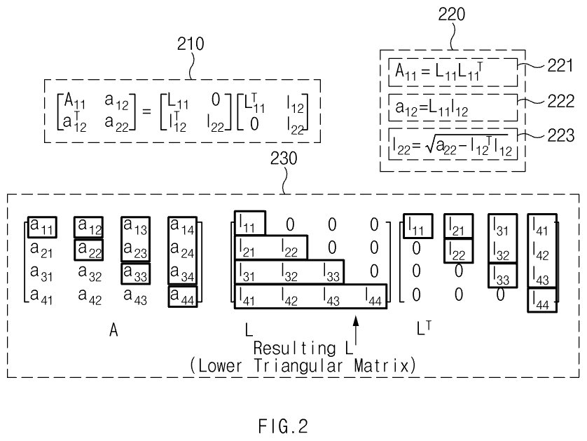

FIG. 2 shows a graphical interpretation of the Cholesky decomposition method for the sparse matrix of FIG. 1.

Referring to FIG. 2, using the equation indicated by reference numeral 210, a leading submatrix (or principal submatrix) A₁₁ may be obtained through the recursive factorization of the positive definite matrix “A”, as illustrated in the equation indicated by reference numeral 221 within reference numeral 220. Here, the leading submatrix of n×n matrix “A” may be selected from set I⊂[1, 2, . . . , n], and obtained by removing all rows and columns whose indices are not I.

For example, in the 4×4 matrix “A” below, the leading submatrix A[2, 4] corresponding to the set {2, 4} may be expressed as follows:

$$A = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ]$$

$$A [ 2 , 4 ] = \vert \begin{matrix}{a}_{22} & {a}_{24} \\ {a}_{42} & {a}_{44}\end{matrix} \vert$$

Further, based on the relation shown in reference numeral 210, the non-diagonal element l₁₂ of the upper triangular matrix L^{T} may be computed by the equation of reference numeral 222 within reference numeral 220, and the diagonal element of the upper triangular matrix L^{T} may be computed by the equation of reference numeral 223 within reference numeral 220.

Reference numeral 230 in FIG. 2 shows a graphical interpretation of the Cholesky decomposition for the 4×4 matrix “A”, and the following MATLAB code is a function of generating the upper triangular matrix of n×n matrix “A” according to the algorithm of FIG. 2.

function = chol_up(A)
n = size (A) ;
L = zeros (n) ;
for k = 1: n
L (k, 1: k−1) = (L (1: k−1, 1: k−1) \ A (1: k−1, k))’ ;
L (k, k) = sqrt (A (k, k) − L (k,1: k−1) * L (k,1: k−1)’) ;
end

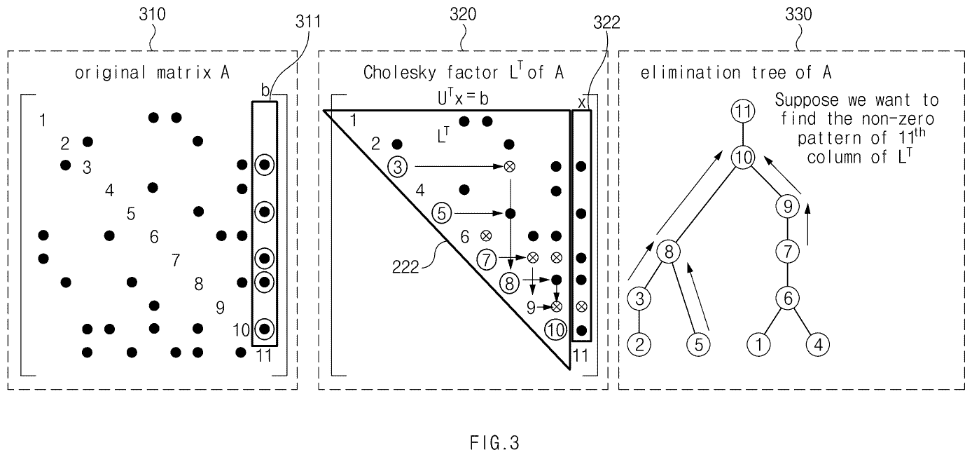

FIG. 3 is a diagram for describing the Cholesky decomposition method for sparse matrices according to another embodiment of the present disclosure.

Referring to reference numerals 310 and 320, “x” may be computed from the upper triangular transpose matrix U^{T} 222 of matrix “A” and the dense vector “b” 311. That is, “x” may be computed using equation U^{T}x=b. For example, when finding out the non-zero values 322—i.e., the non-zero pattern—of the 11th row of L^{T}, the pattern of the 11th column of L^{T} may be expressed by the following equation as illustrated in reference numerals 320 and 330

Lᵢ₁₁[3,5,7,9,10,11]

The elimination tree is a (e.g., special) graph structure for square symmetric matrices and may show a method of preserving the structure of a matrix while eliminating specific elements of the matrix. In MATLAB, the etree function may be used to compute the elimination tree, and the etreeplot function may be used to visually represent the elimination tree, as illustrated by reference numeral 330.

In particular, the Cholesky decomposition method for sparse matrices according to FIG. 3 may reduce the complexity of the Cholesky decomposition and provide a (e.g., faster) sparse matrix algorithm by removing computing the column pointer matrix—that is, determining the column counts—as (e.g., required) in the methods of FIGS. 1 and 2.

To this end, the Cholesky decomposition method for sparse matrices according to the present embodiment may include generating the elimination tree for L^{T} and finding the reach of the elimination tree to determine the pattern of L^{T}. Specifically, the proposed method may use the reach of the elimination tree indicated by the arrows in reference numeral 330 to compute the pattern of each column of L^{T}.

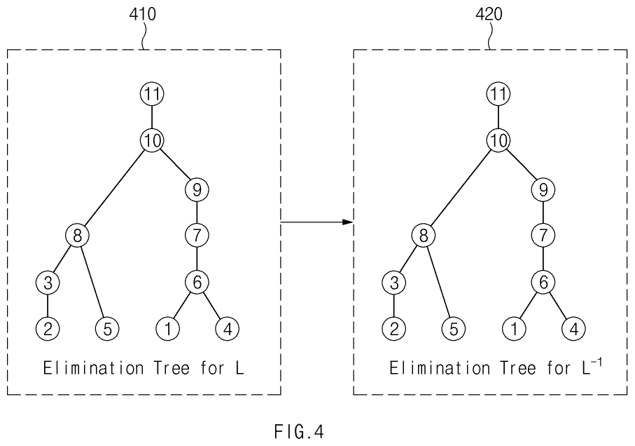

FIG. 4 is a diagram for describing the characteristics of the elimination tree of the lower triangular matrix “L” according to an example embodiment of the present disclosure.

To complete the LL^{T} or Cholesky decomposition, the inverse matrix L⁻¹ of the lower triangular matrix “L” may be computed.

For the solution of a sparse matrix, an elimination tree is used (e.g., required), and symbolic analysis may involve traversing the tree using “L” with respect to both the elimination tree of “L” for the non-zero pattern of L⁻¹.

Referring to FIG. 4, the elimination tree 410 for computing “L” may have the same or similar characteristics as the elimination tree 420 of L⁻¹.

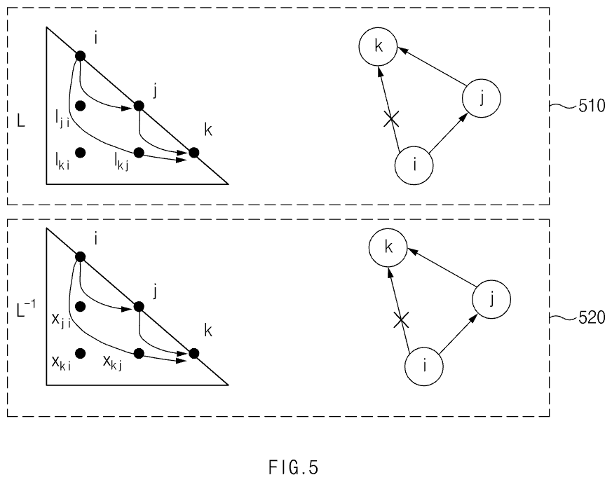

FIG. 5 is a diagram for describing the reason why the elimination tree of the lower triangular matrix “L” is the same as (e.g., identical to) that of L⁻¹, according to an example embodiment of the present disclosure.

First, referring to reference numeral 510, the rules of the elimination tree of “A” for matrix “L” in “A”=LL^{T} are as follows.

aᵢₖ=aᵢₖ≠0 may imply lₖᵢ≠0, and lⱼᵢ≠0 and lₖᵢ≠0 may imply lₖⱼ≠0. Thus, lₖᵢ≠0 may be redundant for graph traversal, and graph traversal may provide a pattern of non-zero rows in “L”.

Referring to reference numeral 520, the rules for the elimination tree of “L” for an L⁻¹ matrix is as follows.

lⱼᵢ≠0 may imply that xⱼᵢ≠0, and xⱼᵢ≠0 and xₖⱼ≠0 may imply that xₖᵢ≠0. Thus, xₖᵢ≠0 is redundant for graph traversal, and the graph traversal may provide a non-zero column pattern of “L”.

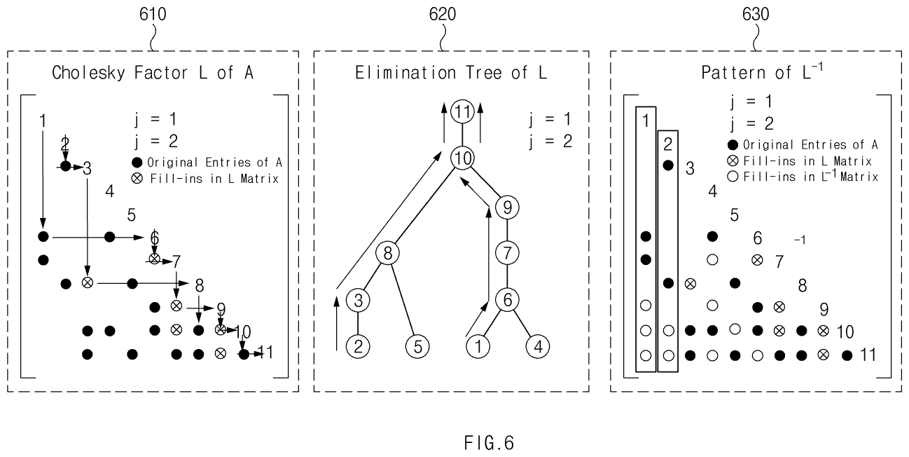

FIG. 6 is a diagram for describing a graph traversal method for an elimination tree according to an example embodiment of the present disclosure.

Referring to FIG. 6, reference numeral 610 shows a lower triangular matrix “L” of the Cholesky decomposition components (LL^{T}) of a matrix “A”, reference numeral 620 shows an elimination tree of “L”, and reference numeral 630 shows a pattern of the inverse matrix L⁻¹, which is also a lower triangular matrix.

To obtain the inverse matrix L⁻¹ of the lower triangular matrix of the dense matrix “A”, it may be used (e.g., required) to generate the elimination tree corresponding to the lower triangular matrix “L”. As described in FIGS. 4 and 5 above, the elimination trees of the sparse matrix “L” and its inverse matrix L⁻¹ may be the same.

Therefore, the nodes of the elimination tree corresponding to the lower triangular matrix “L” may be sequentially traversed from the lowest node to the highest node to extract the column pattern corresponding to L⁻¹.

Finally, L⁻¹ may be generated using the extracted column pattern corresponding to L⁻¹.

In other words, as illustrated in FIG. 6, graph traversal (or traversal of reach of the grape) may be performed by sequentially moving from the lowest node to the highest node (root node) in the elimination tree.

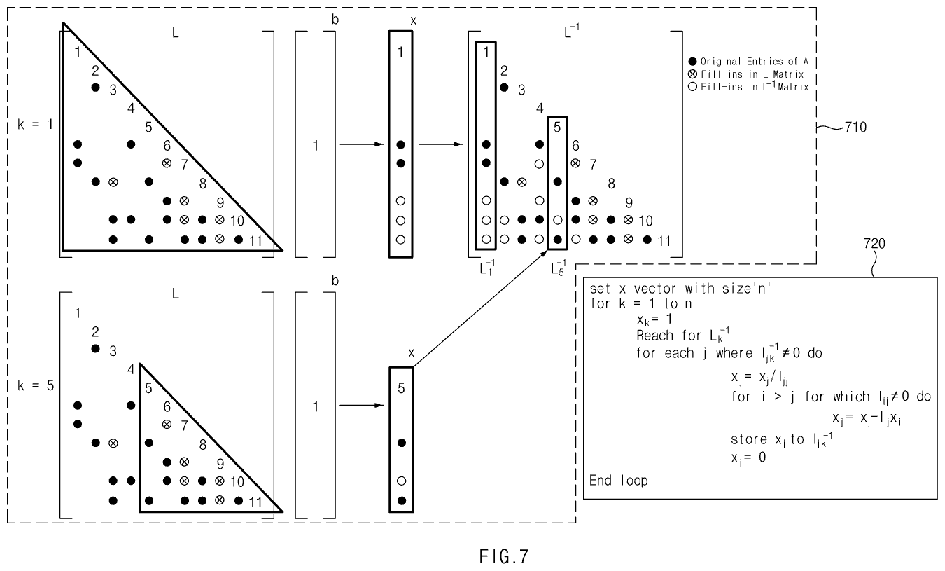

FIG. 7 is a diagram for describing a method for numerically computing a sparse matrix L⁻¹ according to an example embodiment of the present disclosure.

The numerical computation of the sparse matrix L⁻¹ may involve a triangular solve for each column of the matrix L⁻¹. Thus, solving Lx=b may be performed sequentially, from the first column (k=1) to the last column (k=11) of the matrix “L”, as indicated by reference numeral 710 in FIG. 7.

Reference numeral 720 shows an example of implementing, with MATLAB codes, the above-described numerical computation method for the sparse matrix L⁻¹.

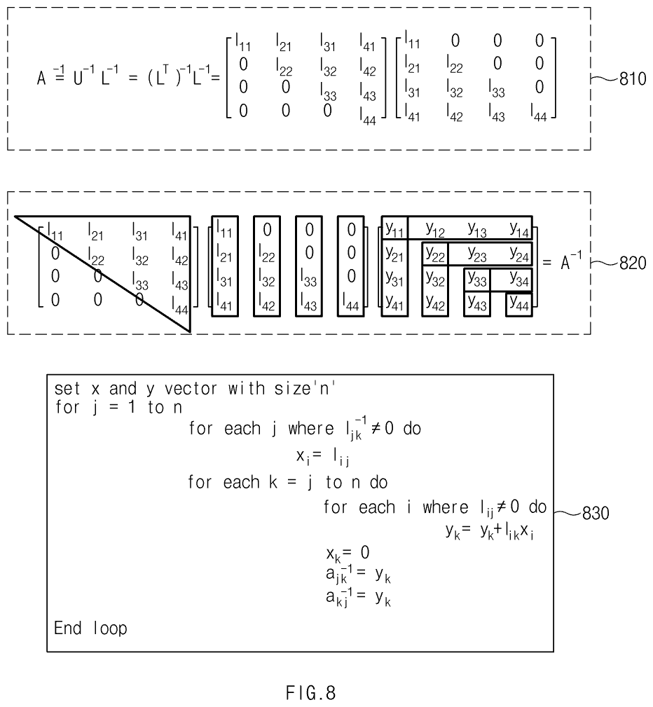

FIG. 8 is a diagram for describing a method for obtaining the inverse matrix of “A” using a sparse matrix L⁻¹, according to an example embodiment of the present disclosure.

The algorithm for obtaining the inverse matrix A⁻¹ of “A” may (e.g., require) performing sparse matrix processing, as indicated by reference numeral 810. Here, A⁻¹ is a dense matrix.

A sparse matrix-vector multiplication method—i.e., L^{T}×b—may be applied to solve the equation of reference numeral 810, but this is only one embodiment, and methods according to other embodiments may extend the sparse matrix-matrix multiplication method to obtain faster results, as indicated by reference numeral 820 in FIG. 7.

Reference numeral 830 shows an example of implementing, with MATLAB codes, the inverse matrix of “A” using a sparse matrix “L⁻¹”.

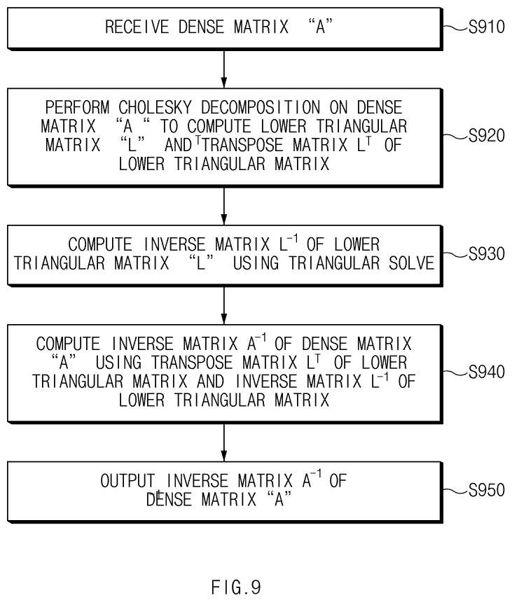

FIG. 9 is a flowchart for describing a Cholesky decomposition method for obtaining an inverse matrix using a sparse matrix according to an example embodiment of the present disclosure.

The method of FIG. 9 may be performed by a computing device 1400 of FIG. 15, which will be described later.

Referring to FIG. 9, the computing device 1400 may receive a dense matrix “A” (S910).

The computing device 1400 may perform Cholesky decomposition on the dense matrix “A” to compute a lower triangular matrix “L” and a transpose matrix L^{T} of the lower triangular matrix,—i.e., an upper triangular matrix “U”—(S920). Here, “A” may be represented as LL^{T}, and the lower triangular matrix “L” and the upper triangular matrix L^{T} are sparse matrices.

The computing device 1400 may compute the inverse matrix L⁻¹ of the lower triangular matrix “L” using triangular solve (S930). Here, L⁻¹ is a sparse matrix.

The computing device 1400 may compute the inverse matrix A⁻¹ of the dense matrix “A” using the transpose matrix L^{T} of the lower triangular matrix and the inverse matrix L⁻¹ of the lower triangular matrix (S940). That is, A⁻¹ may be computed as U⁻¹L⁻¹=(L^{T})⁻¹L⁻¹.

The computing device 1400 may output the inverse matrix A⁻¹ of the dense matrix “A” (S950).

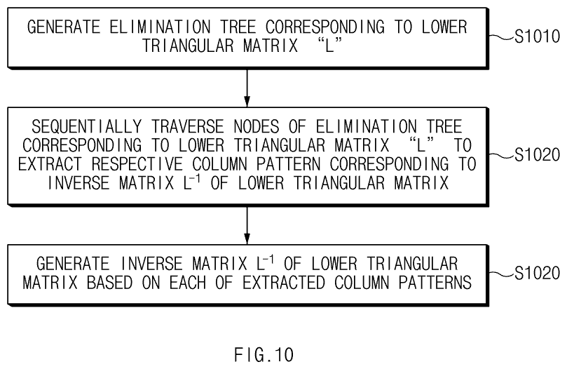

FIG. 10 is a flowchart for describing a detailed method for computing the inverse matrix L⁻¹ of the lower triangular matrix “L” of FIG. 9.

Referring to FIG. 10, the computing device 1400 may generate an elimination tree corresponding to the lower triangular matrix “L” (S1010).

The computing device 1400 may sequentially traverse the nodes of the elimination tree corresponding to the lower triangular matrix “L” to extract a respective column pattern corresponding to the inverse matrix L⁻¹ of the lower triangular matrix (S1020).

The computing device 1400 may generate the inverse matrix L⁻¹ of the lower triangular matrix based on each of the extracted column patterns (S1030).

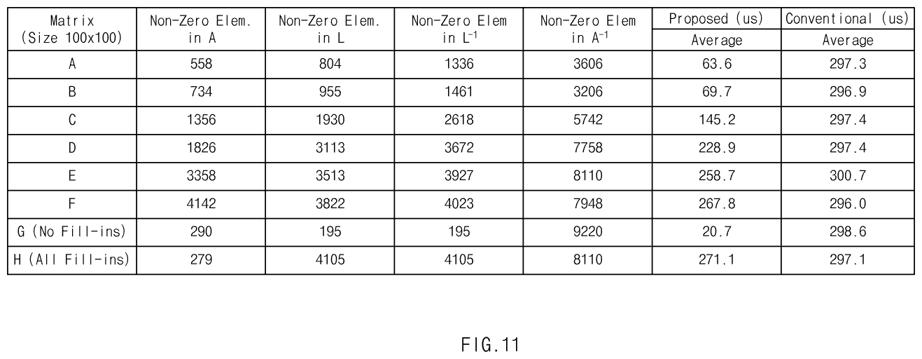

FIG. 11 illustrates a method for computing the inverse matrix A⁻¹ of a dense matrix “A” utilizing the inverse matrix of a symmetric positive definite sparse matrix via LL^{T} factorization according to an example embodiment of the present disclosure, as well as performance test results of prior art.

Conventional methods may obtain the inverse matrix of a dense matrix by inputting a dense matrix;

computing LL^{T}; computing the inverse matrix; and/oroutputting the inverse matrix of the dense matrix.

In comparison, the process for obtaining the inverse matrix of a dense matrix using a sparse matrix proposed in the present disclosure may include: inputting a dense matrix; converting the dense matrix to a sparse matrix; computing sparse LL^{T}; computing sparse inverse matrix; and/or
outputting inverse matrix of dense matrix.

As shown in FIG. 11, the time (e.g., required) to compute the inverse matrix of a dense matrix is (e.g., significantly) reduced in the proposed disclosure compared to conventional methods, regardless of the type of matrix used in the experiment or the number of non-zero elements contained in the matrix.

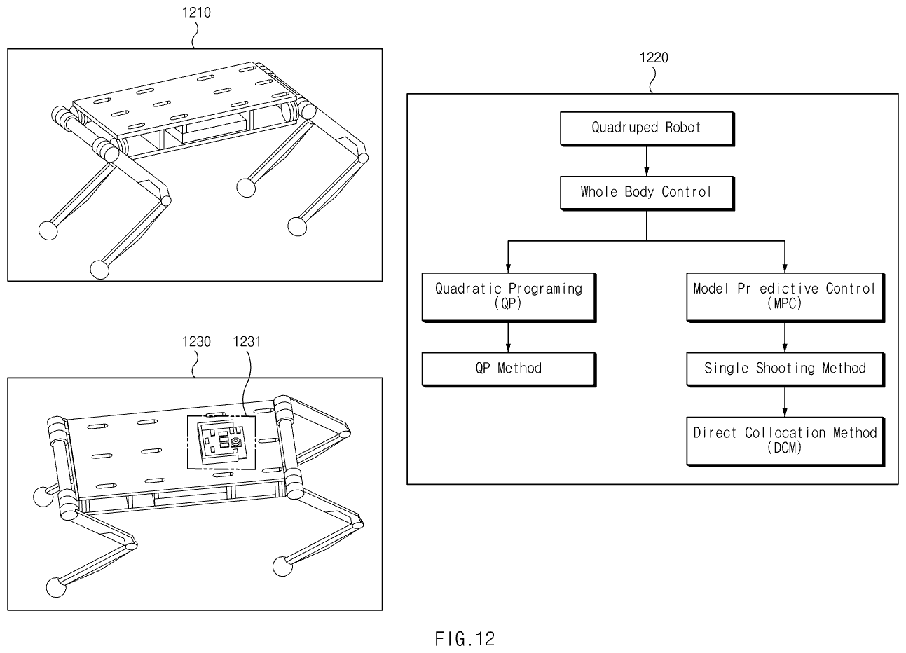

FIG. 12 shows an example of a device to which the Cholesky decomposition method for computing an inverse matrix using a sparse matrix is applied.

In general, robots use (e.g., require) high-speed computation, which may be controlled by real-time modules. In many robotic applications, a loop may (e.g., need to) execute in real time. For example, in robot control, real-time modules that maintain processing times at fixed intervals are used, such as Xenomai. These fixed intervals may vary by application, but are typically 1 ms or 10 ms.

As shown in reference numeral 1210, the present disclosure may be applied to, but is not limited to, a four-legged robot that uses (e.g., requires) real-time control with high-speed computation, and may be applied to a variety of devices that use (e.g., require) high-speed determination and control.

As shown in reference numeral 1220, Quadratic Programming (QP) and Model Predictive Control (MPC) may be used for whole-body control of a four-legged robot.

QP is a type of nonlinear programming that solves specific mathematical optimization problems involving quadratic functions. In particular, QP is used to optimize (e.g., minimize or maximize) multivariate quadratic functions subject to linear constraints on the variables.

MPC (Model Predictive Control) is a type of optimal control widely used in robotics for planning and control of constrained dynamic systems to minimize a cost function. By using MPC, it is possible to feed various dynamics, such as leg position, torque, velocity, acceleration, and force control of the robot, along with surrounding environment conditions into the cost function to generate an optimized control command tailored to the situation, allowing the robot to perform stable autonomous navigation.

The Single Shooting Method is a core component of MPC, where a state sequence is found by performing a simulation in the current state. Single shooting is a direct optimal control method in which a control signal is discretized and system dynamics are obtained through simulation. The single shooting may be selected because the prediction horizon of the MPC is typically much shorter than the final time.

The Direct Collocation Method (DCM) is an optimal control technique used to transform an Optimal Control Problem (OCP) into a Nonlinear Problem (NLP).

The Cholesky decomposition method using sparse matrices according to the present disclosure may be applied to at least one of QP and MPC, and be utilized as an important component technology for whole-body control of the four-legged robot.

For example, in QP and MPC, the Cholesky decomposition method according to the present disclosure may be used for the purpose of optimizing the following equation.

$$f ( x ) = xTHx + gTx$$

Where “H” is a symmetric positive definite matrix that may be solved using Cholesky decomposition, and the computation of the above equation may be performed by a robot control module. For example, the robot control module may include a “Raspberry Pi Compute Module 4” 1231 as shown in reference numeral 1230. However, this is one embodiment, and alternatives, such as the Beckhoff C6015 or Beckhoff C6030 may also be used.

The approximated directional dynamics and translational dynamics may be combined in the form of the following equation.

$$\frac{d}{dt} [ \begin{matrix}\hat{Θ} \\ \hat{P} \\ \hat{ω} \\ \hat{\dot{P}}\end{matrix} ] = [ \begin{matrix}{0}_{3} & {0}_{3} & {R}_{z} ( ψ ) & {0}_{3} \\ {0}_{3} & {0}_{3} & {0}_{3} & {1}_{3} \\ {0}_{3} & {0}_{3} & {0}_{3} & {0}_{3} \\ {0}_{3} & {0}_{3} & {0}_{3} & {0}_{3}\end{matrix} ] [ \begin{matrix}\hat{Θ} \\ \hat{P} \\ \hat{ω} \\ \hat{\dot{P}}\end{matrix} ] + [ \begin{matrix}{0}_{3} & ⋯ & {0}_{3} \\ {0}_{3} & ⋯ & {0}_{3} \\ {{\hat{I}}^{- 1} [ {r}_{1} ]}_{x} & ⋯ & {{\hat{I}}^{- 1} [ {r}_{n} ]}_{x} \\ \frac{{1}_{3}}{m} & ⋯ & \frac{{1}_{3}}{m}\end{matrix} ] [ \begin{matrix}{f}_{1} \\ ⋮ \\ {f}_{n}\end{matrix} ] + [ \begin{matrix}0 \\ 0 \\ 0 \\ g\end{matrix} ]$$

\hat{Θ}=[φ θ ψ]^{T} may be an orientatior vector. \hat{P} may be a position vectio. \hat{ω} may be an angular velocity vector. \dot{P} may be a translational velocity vector. R_{z} may be a rotation matrix in z-axis. f₁ may be a ground reaction force. g may be an acceleration of gravity. Î may be a robot's inertia tensor. U may be a ground reaction force vector.

The equation may also be rewritten as \dot{x}(t)=A_{c}(ψ)x(t)+B_{c}(r₁, . . . , rₙ, ψ)u(t) or X=A_{qp}x₀+B_{pq}U.

The desired ground reaction force (or vector U) may be obtained through a discrete-time finite-horizon Model Predictive Controller (MPC), and the Quadratic Programming (QP) problem, which forms the core of the MPC may be derived from the equation.

Here, a QP (Quadratic Programming) problem refers to the problem of minimizing a quadratic objective function and finding the parameter “x”, as shown in the following equation.

$$minimize x f ( x ) = \frac{1}{2} {x}^{T} {P}_{x} + {C}^{T} x$$

In this case, the following constraints are applied.

$$Gx - h \leq 0$$

$$Ax - b = 0$$

$$P ∈ {R}^{n \times n} ( symmetric positive definite matrix )$$

$$x ∈ {R}^{n} ; c ∈ {R}^{n}$$

$$a ∈ {R}^{0 \times n} ; b ∈ {R}^{0}$$

$$G ∈ {R}^{m \times n} ; h ∈ {R}^{m}$$

For control of the four-legged robot, an objective function may be formulated as shown in the equation below.

$$J ( U ) = {‖ {A}_{pq} {X}_{0} + {B}_{pq} U - {X}_{ref} ‖}_{L} + {‖ U ‖}_{K}$$

The QP problem may be expressed by the following equation.

$$U ( min ) \qquad \frac{1}{2} {U}^{T} HU + {U}^{T} g$$

$$s . t . \qquad \underline{c} \leq CU \leq \overline{c}$$

Herein, C is a constraint matrix and

$$H = 2 ( {B}_{pq}^{T} {LB}_{pq} + K )$$

$$g = 2 {B}_{pq}^{T} L ( {A}_{pq} {x}_{0} - y )$$

In applications related to robot control, the Cholesky decomposition may be used to solve the QP problem.

The solution to the QP problem may require solving the following set of equations.

The algorithm that utilizes the inverse matrix L⁻¹ of a sparse matrix to obtain the inverse matrix of a dense matrix according to the present disclosure may enable solving the above problem using a sparse matrix data structure.

In other words, the proposed method may implement a sparse version of a QP solver, as represented by the following equation.

$$P = {LL}^{T}$$

$$B = {L}^{- 1} N$$

$$[ {J}_{1} : {J}_{2} ] = [ {L}^{- T} {Q}_{1} : {L}^{- T} {Q}_{2} ]$$

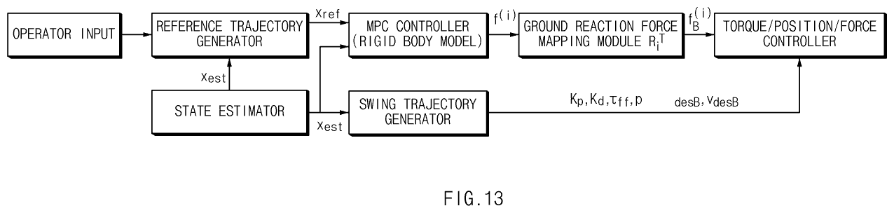

FIG. 13 is a block diagram of a control system for a four-legged robot according to an example embodiment of the present disclosure.

Referring to FIG. 13, the control system may include a reference trajectory generator, a state estimator, a swing trajectory generator (or swing planner), an MPC controller, a ground reaction force mapping module, and a torque/position/force controller.

Operator inputs may include information such as gait patterns, desired velocity, and posture angles.

The state estimator may measure or estimate the current state of a robot.

The reference trajectory generator may plan a desired path within the prediction horizon based on the operator input and the robot's current state.

The swing trajectory generator (or swing planner) may be used to select the gait pattern of the robot and may determine the phase relationship and lift-off timing. The symbol Ó represents the joint PD control parameter, the feedforward force, the desired foot position in the body coordinate frame, and the desired foot velocity in the body coordinate frame, respectively.

At each time phase, the MPC controller may receive or estimate the current state information of the plant. Based on an internal plant model, the MPC controller may solve a constrained optimization problem according to the current system state and compute a sequence of control actions that minimize the cost over the horizon. Subsequently, the MPC controller may disregard the remaining control actions and apply only the first computed control action to the plant. The above-described process may be repeated in the next time phase.

The MPC controller may compute the (e.g., required) Ground Reaction Force (GRF) based on at least one of a planned trajectory provided by the reference trajectory generator, the timing information provided by the swing trajectory generator, and the current state of the robot. For example, the MPC controller may compute and output a desired GRF based on the output of the reference trajectory generator.

The ground reaction force mapping module may convert the GRF in the world coordinate system, input from the MPC controller, into a GRF in the ontology coordinate system.

The torque/position/force controller may execute the timing information provided by the swing trajectory generator and control commands (e.g., required) to drive the robot.

In FIG. 13, X_{ref} is the reference state information of the robot, Xₑₛₜ is the estimated state information of the robot, is the GRF in the world coordinate system, and is the GRF in the ontology coordinate system. “Ó” represents the joint PD control parameter, the feedforward force, the desired foot position in the body coordinate frame, and the desired foot velocity in the body coordinate frame, respectively. The swing leg may be position-controlled, and the effect of joint control may be adjusted based on a PD control gain.

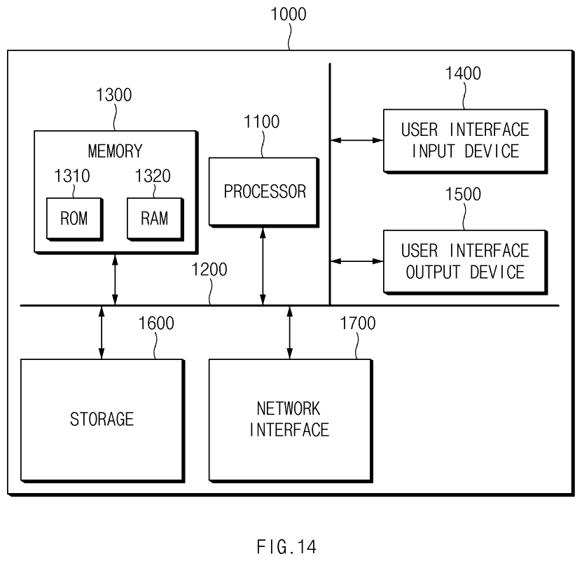

FIG. 14 illustrates a computing device according to an example embodiment of the present disclosure.

Referring to FIG. 14, the computing device 1400 may include at least one of at least one processor 1420, a memory 1430, a user interface input device 1440, a user interface output device 1450, storage 1460, and a network interface 1470, which are connected with each other via a bus 1410.

The processor 1420 may be a central processing unit (CPU) or a semiconductor device that processes instructions stored in the memory 1430 and/or the storage 1460. The memory 1430 and the storage 1460 may include various types of volatile or non-volatile storage media. For example, the memory 1430 may include a ROM (Read Only Memory) 1431 and a RAM (Random Access Memory) 1432.

Thus, the operations of the method or the algorithm described in connection with the embodiments disclosed herein may be embodied (e.g., directly) in hardware or a software module executed by the processor 1420, or in a combination thereof. The software module may reside on a storage medium (that is, the memory 1430 and/or the storage 1460) such as a RAM, a flash memory, a ROM, an EPROM, an EEPROM, a register, a hard disk, a removable disk, and a CD-ROM. For example, the processor 1420 may be used for whole-body control of a four legged robot, including a robot control module and a real-time module, but is not limited thereto.

The example storage medium may be coupled to the processor 1420, and the processor 1420 may read information out of the storage medium and may record information in the storage medium. Alternatively, the storage medium may be integrated with the processor 1420. The processor and the storage medium may reside in an application specific integrated circuit (ASIC). The ASIC may reside within a driver terminal. In another case, the processor and the storage medium may reside in the driver terminal as separate components.

The above description is illustrative of the technical idea of the present disclosure, and various modifications and variations may be made without departing from the essential characteristics of the present disclosure by those skilled in the art to which the present disclosure pertains.

Therefore, the example embodiments of the present disclosure are provided to explain the present disclosure, but not to limit them, so that the present disclosure is not limited by the embodiments. The scope of protection of the present disclosure should be interpreted by the following claims, and technical ideas within the scope equivalent thereto should be construed as being included in the scope of the present disclosure.

The present technology provides a Cholesky decomposition method for computing an inverse matrix using a sparse matrix, and a device utilizing the same.

In addition, the present technology provides a real-time computing device, including a robot controller, to which a (e.g., fast and efficient) Cholesky decomposition technique for computing an inverse matrix using a sparse matrix is applied.

Furthermore, the present disclosure provides a Cholesky decomposition technique for computing an inverse matrix using a sparse matrix, which is applicable to heterogeneous devices and/or systems.

Moreover, the present technology provides a Cholesky decomposition technique utilizing sparse matrices, which provides (e.g., enables) a more stable and faster control in environments that use (e.g., require) real-time computing, such as robot controllers.

In addition, various effects may be provided that are directly or indirectly understood through the disclosure.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A Cholesky decomposition method in a computing device, comprising:
receiving a dense matrix A as input;
generating a lower triangular matrix L and a transposed matrix L^{T} of the lower triangular matrix by performing Cholesky decomposition on the dense matrix A;
computing an inverse matrix L⁻¹ of the lower triangular matrix L using triangular solving;
computing an inverse matrix A⁻¹ of the dense matrix A using the transposed matrix L^{T} and the inverse matrix L⁻¹ of the lower triangular matrix L; and
outputting the inverse matrix A⁻¹ to the computing device including a control module configured to control a hardware device using the output inverse matrix A⁻¹.

2. The method of claim 1, wherein the generating of the transposed matrix L^{T} of the lower triangular matrix includes
generating an elimination tree corresponding to the lower triangular matrix L;
sequentially traversing nodes of the elimination tree to extract respective column patterns corresponding to the inverse matrix L⁻¹ of the lower triangular matrix L; and
generating the transposed matrix L^{T} of the lower triangular matrix based on the extracted column patterns.

3. The method of claim 2, wherein the elimination tree corresponding to the lower triangular matrix L is the same as an elimination tree corresponding to the inverse matrix L⁻¹ of the lower triangular matrix.

4. The method of claim 2, wherein a non-zero pattern of each column of the inverse matrix L⁻¹ of the lower triangular matrix is extracted by identifying a reach from a lowest-level node to a highest-level node of the elimination tree.

5. The method of claim 4, wherein the reach is identified with respect to non-zero elements of the dense matrix A.

6. The method of claim 1, wherein the lower triangular matrix L and the inverse matrix L⁻¹ of the lower triangular matrix are sparse matrices.

7. The method of claim 1, wherein the triangular solving uses an equation of Lx=b, where L is the lower triangular matrix, x is a vector element corresponding to a column pattern of the inverse matrix L⁻¹ of the lower triangular matrix, and b is a vector element indicating a column of L⁻¹.

8. The method of claim 1, wherein the inverse matrix A⁻¹ is computed as a product of an inverse matrix (L^{T})⁻¹ of the transposed matrix and the inverse matrix L⁻¹ of the lower triangular matrix, where the dense matrix A is a symmetric positive-definite matrix, and n is a natural number.

9. The method of claim 1, wherein the Cholesky decomposition method is embedded in the control module of a robot with a Quadratic Programming (QP) method and a Model Predictive Control (MPC) method for whole-body control of the robot.

10. The method of claim 1, wherein the computing device is equipped with a real-time module configured to maintain processing time at fixed intervals.

11. A computing device comprising:
a memory storing computer-executable instructions; and
at least one processor configured to access the memory and execute the instructions, wherein the instructions comprise: receiving a dense matrix A as input,
generating a lower triangular matrix L and a transposed matrix L^{T} of the lower triangular matrix by performing Cholesky decomposition on the dense matrix A,
computing an inverse matrix L⁻¹ of the lower triangular matrix L using triangular solving, computing an inverse matrix A⁻¹ of the dense matrix A using the transposed matrix L^{T} and the inverse matrix L⁻¹ of the lower triangular matrix L, and
outputting the inverse matrix A⁻¹ to the computing device including a control module configured to control a hardware device using the output inverse matrix A⁻¹.

12. The computing device of claim 11, wherein the instructions further comprise generating an elimination tree corresponding to the lower triangular matrix L, sequentially traversing nodes of the elimination tree to extract respective column patterns corresponding to the inverse matrix L⁻¹ of the lower triangular matrix L, and generating the transposed matrix L^{T} of the lower triangular matrix based on the extracted column patterns.

13. The computing device of claim 12, wherein the elimination tree corresponding to the lower triangular matrix L is the same as an elimination tree corresponding to the inverse matrix L⁻¹ of the lower triangular matrix.

14. The computing device of claim 12, wherein the instructions further comprise extracting a non-zero pattern of each column of the inverse matrix L⁻¹ of the lower triangular matrix by identifying a reach from a lowest-level node to a highest-level node of the elimination tree.

15. The computing device of claim 14, wherein the instructions further comprise identifying the reach with respect to non-zero elements of the dense matrix A.

16. The computing device of claim 11, wherein the lower triangular matrix L and the inverse matrix L⁻¹ of the lower triangular matrix are sparse matrices.

17. The computing device of claim 11, wherein the triangular solving uses an equation Lx=b, where L is the lower triangular matrix, x is a vector element corresponding to a column pattern of the inverse matrix L⁻¹ of the lower triangular matrix, and b is a vector element indicating a column of L⁻¹.

18. The computing device of claim 11, wherein the inverse matrix A⁻¹ is computed as a product of an inverse matrix (L^{T})⁻¹ of the transposed matrix and the inverse matrix L⁻¹ of the lower triangular matrix, where the dense matrix A is a symmetric positive-definite matrix, and n is a natural number.

19. The computing device of claim 11, wherein the Cholesky decomposition is embedded in the control module of a robot together with a Quadratic Programming (QP) method and a Model Predictive Control (MPC) method for whole-body control of the robot.

20. The computing device of claim 11, wherein the computing device is equipped with a real-time module configured to maintain processing time at fixed intervals.
